(19) United States
(12) Patent Application Publication
(10) Pub. No.: US 2017/0104618 A1
(43) Pub. Date: Apr. 13, 2017

(54) ELECTRONIC DEVICE AND OPERATING METHOD OF THE SAME

(71) Applicant: Samsung Display Co., Ltd., Yongin-si (KR)

(72) Inventors: Sangrock YOON, Hwaseong-si (KR); Young-mook CHOI, Seoul (KR); Onsik CHOI, Hwaseong-si (KR)

(21) Appl. No.: 15/163,455

(22) Filed: May 24, 2016

(30) Foreign Application Priority Data
Oct. 12, 2015 (KR) 10-2015-0142384

(51) Int. Cl. H04L 27/26; H04W 28/04; H04L 12/28; H04H 20/12

(52) U.S. Cl. CPC H04L 27/26; H04H 20/12; H04W 28/048; H04L 12/2854; H04W 84/12

(57) ABSTRACT

An electronic device includes a display device including a display panel, a clock generator configured to generate a first control clock having a first frequency, and a controller configured to drive the display panel, a communicator configured to perform communication through a wireless communication channel, and a change signal generator configured to generate a frequency change signal on a basis of a noise generated by the first control clock in the wireless communication channel, wherein the controller includes a receiver configured to receive the frequency change signal through a signal transfer line, and a clock convertor configured to convert, on a basis of the frequency change signal, the first control clock into a second control clock having a second frequency different from the first frequency to reduce the noise.

### CROSS-REFERENCE TO RELATED APPLICATION

This U.S. non-provisional patent application claims priority to and the benefit of Korean Patent Application No. 10-2015-0142384, filed on Oct. 12, 2015, in the Korean Intellectual Property Office, the entire content of which is hereby incorporated by reference.

### BACKGROUND

1. Field

Aspects of the present disclosure herein relate to an electronic device and a method for driving the same.

2. Description of the Related Art

With the development of flat panel display devices, such as liquid crystal displays (LCDs), organic light-emitting diode displays (OLEDs), and the like, compact size display devices have become more prevalent. Such compact size display devices are widely used in portable electronic devices. Furthermore, these display devices are widely used in association with wireless communication devices employing wireless communication technology, such as global positioning system (GPS), digital multimedia broadcasting (DMB), wireless wide area network (WWAN), wireless local area network (WLAN), and/or the like. Wireless communication, which is a technology for transmitting/receiving information signals via electromagnetic waves using space as a transmission medium, is widely used due to less spatial constraints.

### SUMMARY

Aspects of embodiments of the present disclosure are directed toward an electronic device having excellent driving reliability and a method for driving the same.

According to some embodiments of the present invention, there is provided an electronic device including: a display device including a display panel, a clock generator configured to generate a first control clock having a first frequency, and a controller configured to drive the display panel; a communicator configured to perform communication through a wireless communication channel; and a change signal generator configured to generate a frequency change signal on a basis of a noise generated by the first control clock in the wireless communication channel, wherein the controller includes: a receiver configured to receive the frequency change signal through a signal transfer line; and a clock convertor configured to convert, on a basis of the frequency change signal, the first control clock into a second control clock having a second frequency different from the first frequency to reduce the noise.

In an embodiment, a frequency band of the wireless communication channel includes a noise band and a noise free band, and when a first multiplied frequency, of frequencies obtained by multiplying the first frequency by integers, is within the noise band, a first noise is generated by the first control clock, and a level of the first noise exceeds a preset reference noise level.

In an embodiment, when a second multiplied frequency, of frequencies obtained by multiplying the second frequency by integers, is within the noise free band, a second noise is generated by the second control clock, and a level of the second noise is equal to or lower than the preset reference noise level.

In an embodiment, the frequencies obtained by multiplying the second frequency are not within the noise band.

In an embodiment, the change signal generator is further configured to calculate the first noise and the second noise.

In an embodiment, the change signal generator is further configured to compare the first noise with the second noise, and to generate the frequency change signal on a basis of a result of the comparison.

In an embodiment, the electronic device further includes: a storage configured to store first to Nth change signal information respectively corresponding to first to Nth sub frequency change signals of the frequency change signal, wherein the change signal generator is configured to generate, as the frequency change signal, a sub frequency change signal corresponding to one of the first to Nth change signal information, wherein N is a natural number equal to or greater than 1.

In an embodiment, the change signal generator is configured to generate, as the frequency change signal, a Kth sub frequency change signal corresponding to Kth change signal information selected by a user from among the first to Nth change signal information, wherein K is a natural number equal to or smaller than N.

According to some embodiments of the present invention, there is provided a method for driving an electronic device, the method including: generating, by a clock generator of a controller, a first clock having a first frequency; detecting a noise generated when a frequency obtained by multiplying the first frequency by an integer exists within a frequency band of a wireless communication channel; determining when a level of the noise exceeds a reference noise level; generating a frequency change signal when the level of the noise exceeds the reference noise level; converting the first clock into a second clock having a second frequency different from the first frequency on a basis of the frequency change signal; and providing the second clock to an internal circuit of the controller.

In an embodiment, the method further includes: storing first to Nth change signal information respectively corresponding to first to Nth sub frequency change signals of the frequency change signal; and generating, as the frequency change signal, a sub frequency change signal corresponding to one of the first to Nth change signal information, wherein N is a natural number equal to or greater than 1.

In an embodiment, the generating, as the frequency change signal, the sub frequency change signal corresponding to one of the first to Nth change signal information includes generating, as the frequency change signal, a Kth sub frequency change signal corresponding to Kth change signal information selected by a user, wherein K is a natural number equal to or smaller than N.

According to some embodiments of the present invention, there is provided a system for driving an electronic device, the system including: means for generating a first clock having a first frequency; means for detecting a noise generated when a frequency obtained by multiplying the first frequency by an integer exists within a frequency band of a wireless communication channel; means for determining when a level of the noise exceeds a reference noise level; means for generating a frequency change signal when the level of the noise exceeds the reference noise level; means for converting the first clock into a second clock having a second frequency different from the first frequency on a basis of the frequency change signal; and means for providing the second clock to an internal circuit of the controller.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept.

In the drawings:

FIG. 1 is a block diagram illustrating an electronic device including a display device according to an embodiment of the inventive concept;

FIG. 2 is a block diagram illustrating the operation of the control unit and the change signal generating unit illustrated in FIG. 1;

FIG. 3 is a diagram illustrating the operation of the clock converting unit illustrated in FIG. 2;

FIG. 4 is a flow diagram illustrating a method for driving the electronic device illustrated in FIG. 1; and

FIG. 5 is a block diagram illustrating the operation of an electronic device according to another embodiment of the inventive concept.

### DETAILED DESCRIPTION

The present invention may be variously modified and may include various embodiments. However, particular embodiments are exemplarily illustrated in the drawings and are described in detail below. However, it should be understood that the present invention is not limited to specific forms but rather covers all modifications, equivalents or alternatives that fall within the spirit and scope of the present invention.

Like numbers refer to like elements throughout. In the accompanying drawings, the dimensions of structures are exaggerated for clarity of illustration.

Exemplary embodiments of the inventive concept will be described below in more detail with reference to the accompanying drawings.

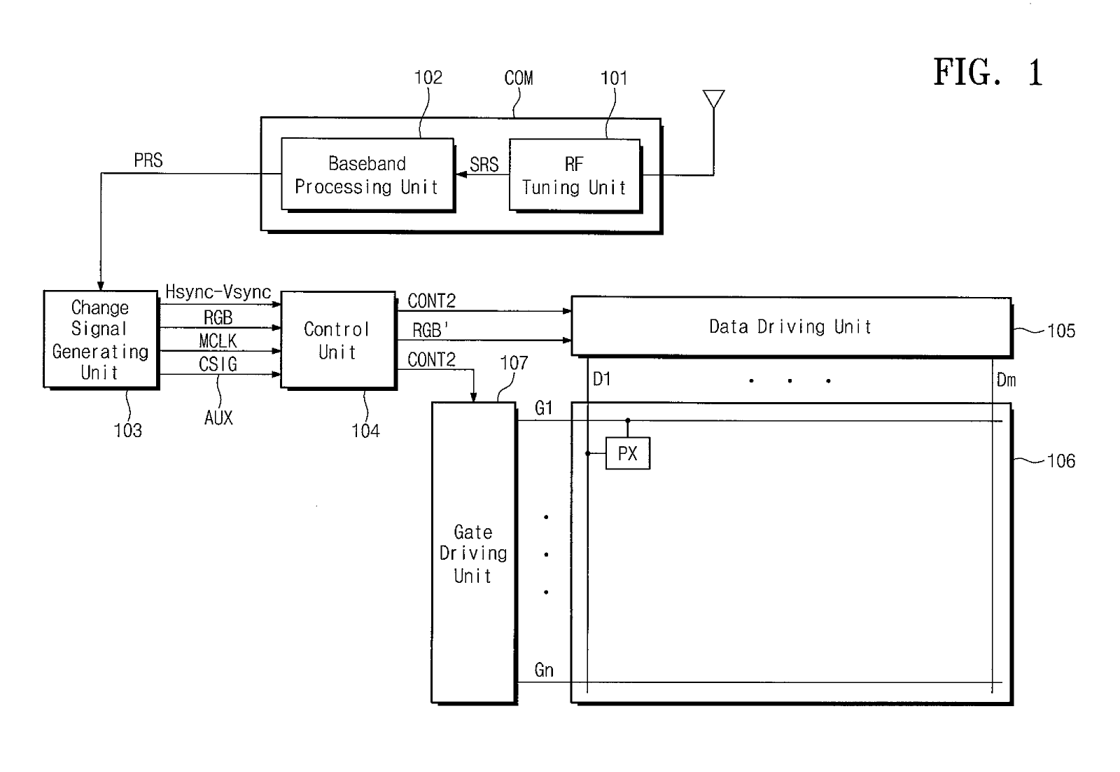

FIG. 1 is a block diagram illustrating an electronic device including a display device according to an embodiment of the inventive concept.

Referring to FIG. 1, an electronic device according to an embodiment of the inventive concept may include a communication unit (e.g., a communicator) COM, a change signal generating unit (e.g., change signal generator) 103, a control unit (e.g., controller) 104, a gate driving unit (e.g., a gate driver) 107, a data driving unit (e.g., a data driver) 105, and a display panel 106.

The control unit 104 receives, from the change signal generating unit 103, input image signals R, G, B and an input control signal for controlling displaying thereof. The input control signal may include, for example, a vertical synchronization signal Vsync, a horizontal synchronization signal Hsync, and a main clock MCLK.

The control unit 104 generates a gate control signal CONT1, a data control signal CONT2, and output image signals R′, G′, B′ on the basis of the input image signals R, G, B and the input control signals Hsync, Vsync, and MCLK. The gate control signal CONT1 is provided to the gate driving unit 107, and the data control signal CONT2 and the output image signals R′, G′, B′ are provided to the data driving unit 105.

In an embodiment of the inventive concept, the input control signal may be generated by an element other than the change signal generating unit 103, for example, an external image source, such as a graphics card.

Furthermore, the control unit 104 receives a frequency change signal CSIG from the change signal generating unit 103. The frequency change signal CSIG may be transferred through a transfer line. In an embodiment of the inventive concept, the transfer line may be an auxiliary channel AUX. The auxiliary channel AUX, which is a bidirectional channel, may serve as an auxiliary channel of the control unit 104 and the change signal generating unit 103, and various signals may be transmitted/received through the auxiliary channel AUX. For example, signals may be transferred through the auxiliary channel AUX from the change signal generating unit 103 to the control unit 104 or from the control unit 104 to the change signal generating unit 103.

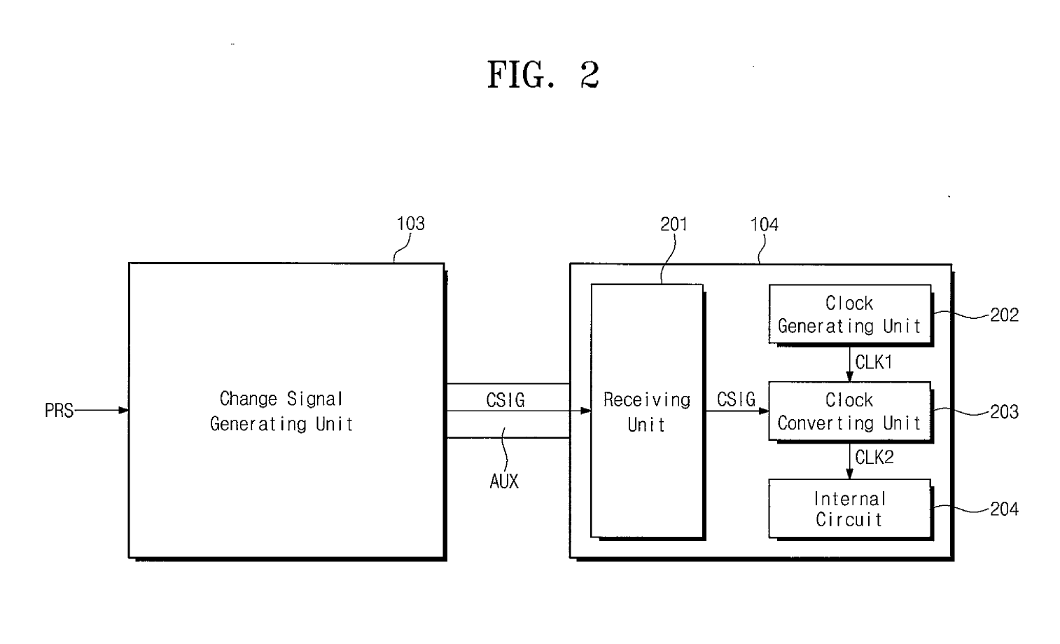

The frequency change signal CSIG is described in further detail below with reference to FIG. 2.

The signals provided by the control unit 104, such as the gate control signal CONT1 and the data control signal CONT2, may be generated on the basis of the main clock MCLK. Therefore, output timings of the signals provided by the control unit 104, such as the gate control signal CONT1 and the data control signal CONT2, may be controlled by the main clock MCLK. A frequency of the main clock MCLK may be a driving frequency of the display panel 106.

The gate control signal CONT1, which is a signal for controlling operation of the gate driving unit 107, includes a vertical start signal for initiating operation of the gate driving unit 107 and a gate clock signal for determining an output timing of a gate-on voltage Von.

The data control signal CONT2, which is a signal for controlling operation of the data driving unit 105, includes a horizontal start signal for initiating operation of the data driving unit 105 and a data clock signal for determining output timings of the output image signals R′, G′, B′.

The display panel 106 includes a plurality of display signal lines and a plurality of pixels PX connected thereto and arranged in a matrix form. The display signal lines include a plurality of gate lines G1 to Gn for transferring a gate signal and a plurality of data lines D1 to Dn for transferring a plurality of data signals. Here, the display panel 106 may be a liquid crystal display (LCD) panel, an organic light-emitting diode (OLED) panel, a plasma display panel (PDP), or the like, according to a method of implementing the pixel PX.

The gate driving unit 107 is connected to the plurality of gate lines G1 to Gn, and applies, in response to the gate control signal CONT1, the gate-on voltage Von and a gate-off voltage Voff provided by a gate-on/off voltage generating unit to the plurality of gate lines G1 to Gn.

The data driving unit 105 is connected to the data lines D1 to Dn, and applies the output image signals R′, G′, B′ to the data lines D1 to Dn in response to the data control signal CONT2.

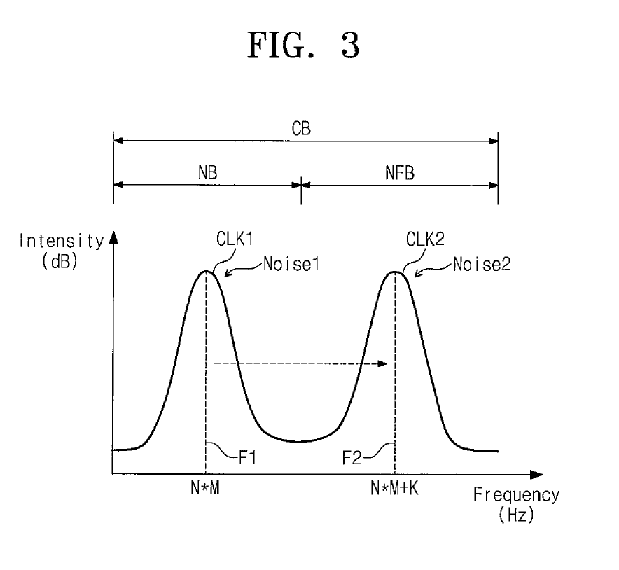

The communication unit COM may receive information carried by a carrier from a receiving side through a wireless communication channel CB (illustrated in FIG. 3). The communication unit COM may include a radio frequency (RF) tuning unit (e.g., an RF tuner) 101 and a baseband processing unit (e.g., a baseband processor) 102.

The RF tuning unit 101 serves to select the wireless communication channel and maintain synchronization therewith in order to receive an input signal. Furthermore, the RF tuning unit 101 provides, to the baseband processing unit 102, a synchronized signal SRS obtained by synchronizing the input signal. Here, the RF tuning unit 101 makes a transmitted input carrier phase and a phase of a local oscillator match each other or maintain a certain temporal relation therebetween within an allowable range, for the purpose of synchronous demodulation of an input signal for wireless communication.

The baseband processing unit 102 demodulates the synchronized signal SRS output from the RF tuning unit 101 into a digital signal PRS. Furthermore, the baseband processing unit 102 separates the signal that has passed through the RF tuning unit 101 into an I-channel signal and a Q-channel signal and filters the I-channel and Q-channel signals using a low-pass filter, and then converts the filtered signals into the digital signal PRS in an analog-to-digital converter (ADC).

The change signal generating unit 103 may receive the digital signal PRS. The change signal generating unit 103 that has received the digital signal PRS may detect a noise contained in the digital signal PRS, and may generate the frequency change signal CSIG in consideration of the detected noise. As described above, the frequency change signal CSIG may be transferred to the control unit 104. As described below, the noise may be generated by first and second control clocks CLK1 and CLK2 (illustrated in FIG. 2) in the wireless communication band. Hereinafter, the term “noise” may represent a noise generated by the first and second control clocks CLK1 and CLK2 in the wireless communication band. The noise is described below in more detail.

FIG. 2 is a block diagram illustrating the operation of the control unit and the change signal generating unit illustrated in FIG. 1; and FIG. 3 is a diagram illustrating the operation of the clock converting unit illustrated in FIG. 2.

Referring to FIG. 2, the change signal generating unit 103 may be connected to the control unit 104 by the auxiliary channel AUX.

Referring to FIG. 3, the wireless communication channel CB may include a noise band NB and a noise free band NFB.

A first multiplied frequency F1, which is one of frequencies obtained by multiplying a first frequency of the first control clock CLK1 by integers, may be within the noise band NB. Herein, a frequency of a clock may represent a center frequency of the clock. Therefore, the first multiplied frequency F1 is a center frequency of one of the frequencies obtained by multiplying the first frequency by integers.

For example, as illustrated in FIG. 3, in the case where the first frequency is M, the first multiplied frequency F1 may be N×M Hz, obtained by multiplying the first frequency by N, where N×M Hz may be a frequency within the noise band NB.

In the case where the first control clock CLK1 has the first multiplied frequency F1, a first noise may be generated. Here, a level of the first noise may exceed a preset reference noise level. The reference noise level may represent an allowable maximum noise level for transmitting data normally during wireless communication.

A second multiplied frequency F2, which is one of frequencies obtained by multiplying a second frequency of the second control clock CLK2 by integers, may not overlap with (e.g., be outside of) the noise band.

For example, as illustrated in FIG. 3, the second multiplied frequency F2 may be shifted from the first multiplied frequency F1 by a set or predetermined frequency. Therefore, as first multiplied frequency F1 is shifted to the second multiplied frequency F2, the first multiplied frequency F1 in the noise band NB may be shifted to the second multiplied frequency F2 in the noise free band NFB.

In the case where the second control clock CLK2 has the second multiplied frequency F2, a second noise may be generated. Here, because the second multiplied frequency F2 is within the noise free band NFB, a level of the second noise may be equal to or lower than the reference noise level.

As described above, the change signal generating unit 103 may calculate the first noise and the second noise. Furthermore, the change signal generating unit 103 may compare the first noise with the second noise, may determine the second frequency on the basis of a result of the comparison, and may generate the frequency change signal CSIG corresponding to the second frequency. The frequency change signal CSIG may be transferred to the control unit 104 through the transfer line such as the auxiliary channel AUX.

The control unit 104 may include a receiving unit (e.g., receiver) 201, a clock generating unit (e.g., a clock generator) 202, a clock converting unit (e.g., the clock converter) 203, and an internal circuit 204.

The receiving unit 201 may receive the frequency change signal CSIG transferred through the transfer line.

The clock generating unit 202 may generate the first control clock CLK1. Unlike the main clock MCLK, the first control clock CLK1 is a clock signal that may be generated by the clock generating unit 202 of the control unit 104 and may be transferred to the internal circuit 204. The clock generating unit 202 transfers the first control clock CLK1 to the clock converting unit 203. The clock converting unit 203 may receive the first control clock CLK1, and may receive, from the receiving unit 201, the frequency change signal CSIG.

The clock converting unit 203 may convert, on the basis of the frequency change signal CSIG, the first control clock CLK1 into the second control clock CLK2 so that a noise level is reduced.

The second control clock CLK2 obtained through conversion based on the frequency change signal CSIG may have the second frequency. The second control clock CLK2 may be transferred to the internal circuit 204. In some examples, the second control clock CLK2 may be an LC clock, an RC clock, or an oscillator (OSC) clock. The internal circuit 204 may be based on resonant oscillation by a combination of a resistor and a capacitor or a combination of an inductor and a capacitor.

Because the first control clock CLK1 is converted into the second control clock CLK2, the level of the noise generated in the wireless communication channel CB may be reduced from the level of the first noise to the level of the second noise. Therefore, the electronic device according to an embodiment of the inventive concept may perform a communication function smoothly (e.g., with fewer transmission errors and greater signal fidelity).

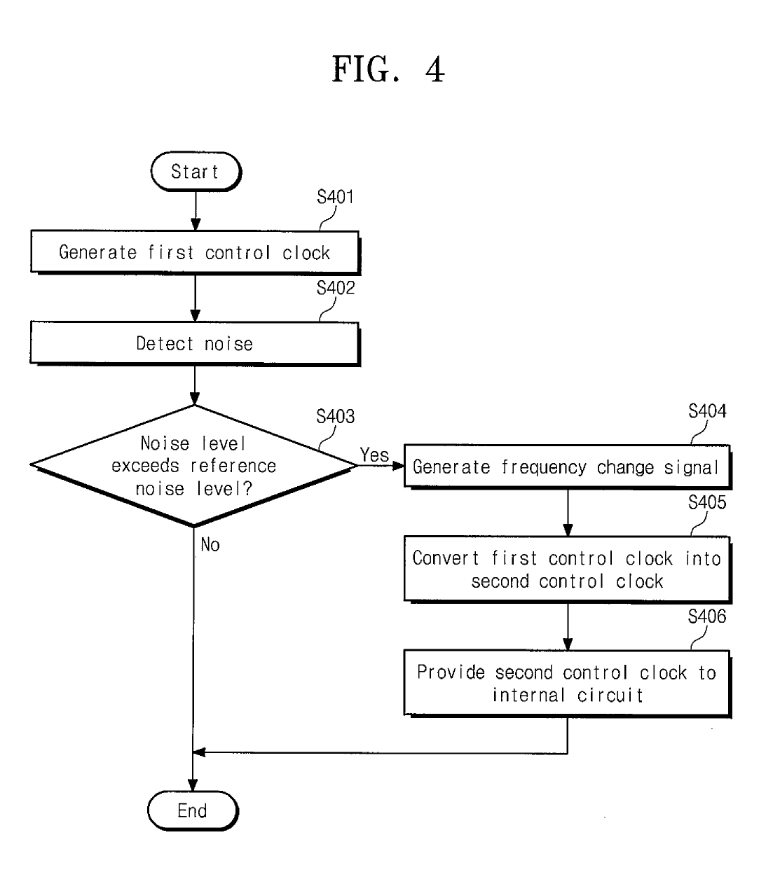

FIG. 4 is a flow diagram illustrating a method for driving the electronic device illustrated in FIG. 1.

Referring to FIGS. 3 and 4, the clock generating unit 202 generates the first control clock CLK1 (S401). Furthermore, the change signal generating unit 103 may detect a noise generated by the first control clock CLK1 (S402). The change signal generating unit 103 may detect the first noise generated by the first multiplied frequency F1.

It is determined whether the level of the first noise exceeds the reference noise level (S403). As described above, if the level of the first noise exceeds the reference noise level, the change signal generating unit 103 generates the frequency change signal CSIG (S404). Because the process of generating the frequency change signal CSIG has been described above with reference to FIGS. 2 and 3, description of the process is not repeated below.

The generated frequency change signal CIG is transferred to the receiving unit 201 of the control unit 104, and the receiving unit 201 transfers the frequency change signal CSIG to the clock converting unit 203. Furthermore, the clock converting unit 203 converts the first control clock CLK1 into the second control clock CLK2 in response to the frequency change signal CSIG (S405). Therefore, the level of the noise is reduced to the level of the second noise, and the second control clock CLK2 is transferred to the internal circuit 204 of the control unit 104 (S406).

If the level of the first noise does not exceed the reference noise level, the change signal generating unit 103 may not generate the frequency change signal CSIG, and driving of the electronic device may be ended. Furthermore, the first control clock CLK1 may be transferred to the internal circuit 204. In some examples, the change signal generating unit 103 may generate the frequency change signal CSIG including instructions to maintain the first control clock CLK1, and the clock converting unit 203 may output the first control clock CLK1 without changing a frequency of the first control clock CLK1 according to the frequency change signal CSIG.

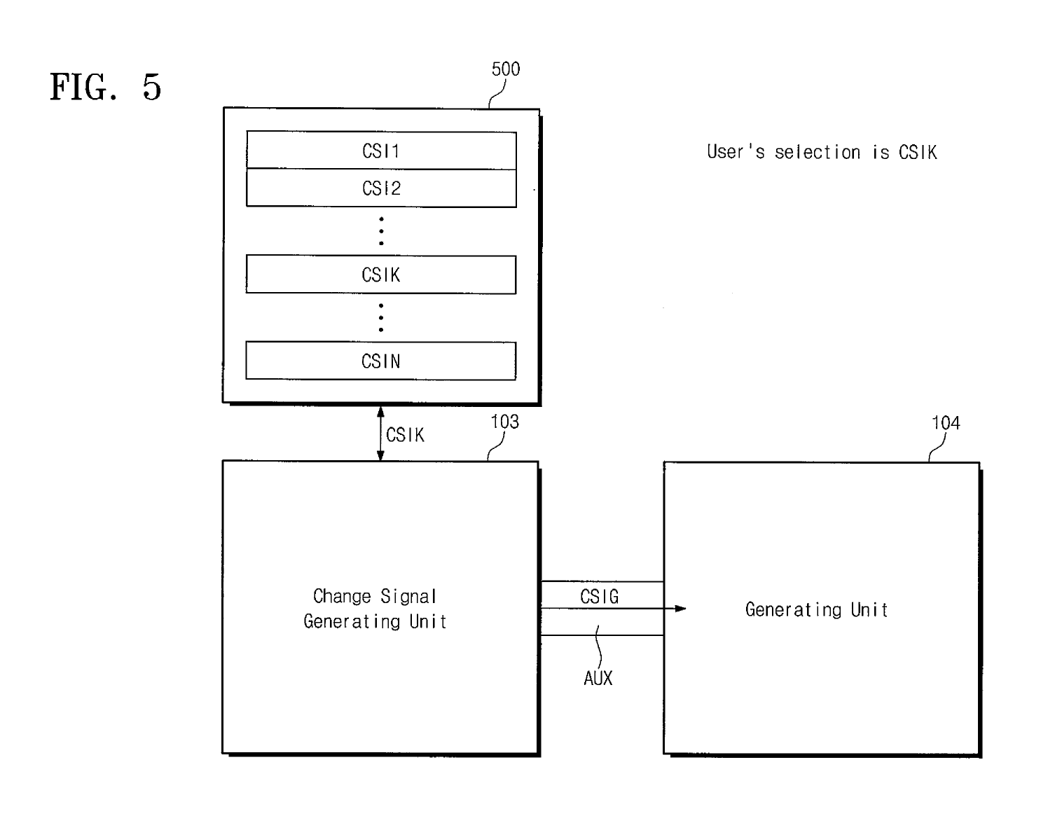

FIG. 5 is a block diagram illustrating the operation of an electronic device according to another embodiment of the inventive concept.

The frequency change signal CSIG may include first to Nth sub frequency change signals, where N is a natural number equal to or greater than 1.

Each of the first to Nth sub frequency change signals may have characteristics of the frequency change signal CSIG described above with reference to FIG. 2.

As illustrated in FIG. 5, the electronic device according to another embodiment of the inventive concept may further include a storage unit (e.g., a storage) 500, as compared to the electronic device illustrated in FIG. 2.

The storage unit 500 may store first to Nth change signal information CSI1 to CSIN corresponding to the first to Nth sub frequency change signals respectively. The first to Nth change signal information CSI1 to CSIN may have different information.

The change signal generating unit 103 may generate a sub frequency change signal corresponding to one of the first to Nth change signal information CSI1 to CSIN.

The change signal generating unit 103 may generate the sub frequency change signal through the same or substantially the same process as that described above with reference to FIGS. 2 and 3.

For example, a wireless communication channel band of a first region may be different from that of a second region. Therefore, a noise band in the wireless communication channel of the first region may be different from that in the wireless communication channel of the second region. Furthermore, a noise free band in the wireless communication channel of the first region may be different from that in the wireless communication channel of the second region.

Therefore, the sub frequency change signal generated by the change signal generating unit 103 in the first region may be different from that generated by the change signal generating unit 103 in the second region. Furthermore, the change signal information corresponding to the sub frequency change signal generated by the change signal generating unit 103 in the first region may be different from that corresponding to the sub frequency change signal generated by the change signal generating unit 103 in the second region, and each change signal information may be stored in the storage unit 500.

Through the same or substantially the same process as that described above, the storage unit 500 may store the first to Nth change signal information CSI1 to CSIN so that the first to Nth change signal information CSI1 to CSIN correspond to first to Nth regions.

For example, in the case where a user of the electronic device of FIG. 5 selects a Kth change signal information CSIK in a specific region, the Kth change signal information CSIK may be transferred to the change signal generating unit 103. The change signal generating unit 103 may generate the Kth sub frequency change signal in response to the Kth change signal information CSIK. The Kth sub frequency change signal may be transferred to the receiving unit 201 of the control unit 104. The following process is the same or substantially the same as that described above, and is thus not repeated below.

Accordingly, the user of the electronic device according to an embodiment of the inventive concept may select one of the first to Nth change signal information CSI1 to CSIN, and the first control clock CLK1 may be converted by the sub frequency change signal corresponding to the selected change signal information, so that the level of the noise generated by the first control clock CLK1 may be reduced and the electronic device may perform a communication function smoothly (e.g., with fewer transmission errors and greater signal fidelity).

According to a conventional method for changing a clock of a control unit, a value of a register in an electrically erasable programmable read-only memory (EEPROM) is adjusted so that a hardware setting of the control unit itself is changed. According to such a conventional method, a user is unable to easily change the clock of the control unit. Therefore, in the case where the user moves to another region and uses an electronic device in that region, the user is limited in using the electronic device due to a noise generated by the clock of the control unit in a wireless communication channel being changed due to the movement to the other region. However, according to an embodiment of the inventive concept, the clock of the control unit may be easily changed by the user using software or firmware. That is, the clock of the control unit is easily changed by user's selection in a specific region, so that the level of the noise generated by the clock of the control unit in a wireless communication channel may be reduced. Accordingly, the driving reliability of the electronic device may be improved (e.g., increased).

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Further, the use of “may” when describing embodiments of the inventive concept refers to “one or more embodiments of the inventive concept.” Also, the term “exemplary” is intended to refer to an example or illustration.

It will be understood that when an element or layer is referred to as being “connected to” or “coupled to” another element, it can be directly connected to or coupled to the other element, or one or more intervening elements may be present. When an element or layer is referred to as being “directly connected to” or “directly coupled to” another element, there are no intervening elements present.

As used herein, the term “substantially,” “about,” and similar terms are used as terms of approximation and not as terms of degree, and are intended to account for the inherent variations in measured or calculated values that would be recognized by those of ordinary skill in the art.

As used herein, the terms “use,” “using,” and “used” may be considered synonymous with the terms “utilize,” “utilizing,” and “utilized,” respectively.

The electronic device and/or any other relevant devices or components according to embodiments of the present invention described herein may be implemented utilizing any suitable hardware, firmware (e.g. an application-specific integrated circuit), software, or a suitable combination of software, firmware, and hardware. For example, the various components of the electronic device may be formed on one integrated circuit (IC) chip or on separate IC chips. Further, the various components of the electronic device may be implemented on a flexible printed circuit film, a tape carrier package (TCP), a printed circuit board (PCB), or formed on a same substrate. Further, the various components of the electronic device may be a process or thread, running on one or more processors, in one or more computing devices, executing computer program instructions and interacting with other system components for performing the various functionalities described herein. The computer program instructions are stored in a memory, which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

Although exemplary embodiments of the present invention have been described, it is understood that the present invention should not be limited to these exemplary embodiments but various suitable changes and modifications can be made by one ordinary skilled in the art within the spirit and scope of the present invention as defined by the appended claims and equivalents thereof.

What is claimed is:

1. An electronic device comprising:
a display device comprising a display panel, a clock generator configured to generate a first control clock having a first frequency, and a controller configured to drive the display panel;
a communicator configured to perform communication through a wireless communication channel; and
a change signal generator configured to generate a frequency change signal on a basis of a noise generated by the first control clock in the wireless communication channel,
wherein the controller comprises:
a receiver configured to receive the frequency change signal through a signal transfer line; and
a clock convertor configured to convert, on a basis of the frequency change signal, the first control clock into a second control clock having a second frequency different from the first frequency to reduce the noise.

2. The electronic device of claim 1,
wherein a frequency band of the wireless communication channel comprises a noise band and a noise free band, and
wherein, when a first multiplied frequency, of frequencies obtained by multiplying the first frequency by integers, is within the noise band, a first noise is generated by the first control clock, and a level of the first noise exceeds a preset reference noise level.

3. The electronic device of claim 2, wherein, when a second multiplied frequency, of frequencies obtained by multiplying the second frequency by integers, is within the noise free band, a second noise is generated by the second control clock, and a level of the second noise is equal to or lower than the preset reference noise level.

4. The electronic device of claim 3, wherein the frequencies obtained by multiplying the second frequency are not within the noise band.

5. The electronic device of claim 3, wherein the change signal generator is further configured to calculate the first noise and the second noise.

6. The electronic device of claim 5, wherein the change signal generator is further configured to compare the first noise with the second noise, and to generate the frequency change signal on a basis of a result of the comparison.

7. The electronic device of claim 1, further comprising:
a storage configured to store first to Nth change signal information respectively corresponding to first to Nth sub frequency change signals of the frequency change signal,
wherein the change signal generator is configured to generate, as the frequency change signal, a sub frequency change signal corresponding to one of the first to Nth change signal information, wherein N is a natural number equal to or greater than 1.

8. The electronic device of claim 7, wherein the change signal generator is configured to generate, as the frequency change signal, a Kth sub frequency change signal corresponding to Kth change signal information selected by a user from among the first to Nth change signal information, wherein K is a natural number equal to or smaller than N.

9. A method for driving an electronic device, the method comprising:
generating, by a clock generator of a controller, a first clock having a first frequency;
detecting a noise generated when a frequency obtained by multiplying the first frequency by an integer exists within a frequency band of a wireless communication channel;
determining when a level of the noise exceeds a reference noise level;
generating a frequency change signal when the level of the noise exceeds the reference noise level;
converting the first clock into a second clock having a second frequency different from the first frequency on a basis of the frequency change signal; and
providing the second clock to an internal circuit of the controller.

10. The method of claim 9, further comprising:
storing first to Nth change signal information respectively corresponding to first to Nth sub frequency change signals of the frequency change signal; and
generating, as the frequency change signal, a sub frequency change signal corresponding to one of the first to Nth change signal information, wherein N is a natural number equal to or greater than 1.

11. The method of claim 10, wherein the generating, as the frequency change signal, the sub frequency change signal corresponding to one of the first to Nth change signal information comprises generating, as the frequency change signal, a Kth sub frequency change signal corresponding to Kth change signal information selected by a user, wherein K is a natural number equal to or smaller than N.

12. A system for driving an electronic device, the system comprising:
means for generating a first clock having a first frequency;
means for detecting a noise generated when a frequency obtained by multiplying the first frequency by an integer exists within a frequency band of a wireless communication channel;
means for determining when a level of the noise exceeds a reference noise level;
means for generating a frequency change signal when the level of the noise exceeds the reference noise level;
means for converting the first clock into a second clock having a second frequency different from the first frequency on a basis of the frequency change signal; and
means for providing the second clock to an internal circuit of the controller.
